(19) United States
(12) Patent Application Publication
(10) Pub. No.: US 2004/0058650 A1
(43) Pub. Date: Mar. 25, 2004

(54) Receivers and methods for searching for cells using recorded data

(76) Inventors: Torgny Palenius, Loddekopinge (SE); Michael Breschel, Lund (SE)

Correspondence Address: MYERS BIGEL SIBLEY & SAJOVEC, PO BOX 37428, RALEIGH, NC, 27627, US

(21) Appl. No.: 10/324,414

(22) Filed: Dec. 20, 2002

Related U.S. Application Data
(60) Provisional application No. 60/411,887, filed on Sep. 19, 2002.

(51) Int. Cl. H04B 1/44

(52) U.S. Cl. 455/67.11

(57) ABSTRACT

A mobile terminal includes a wireless receiver, a buffer, and a controller. The wireless receiver is configured to receive information from a plurality of cells. The buffer is configured to record the information. The controller is configured to search the information for a first synchronization code from at least one of the plurality of cells, and to search for a second synchronization code from at least one of the plurality of cells using the information that was recorded in the buffer and used to search for the first synchronization code.

### CROSS-REFERENCE TO PROVISIONAL APPLICATION

This application claims the benefit of provisional Application No. 60/411,887, filed Sep. 19, 2002, entitled Recording IQ-DATA And Playback, the disclosure of which is hereby incorporated herein by reference in its entirety as if set forth fully herein.

### FIELD OF THE INVENTION

This invention relates to wireless communication receivers and operating methods therefor, and more particularly to wireless receivers and operating methods for using IQ data for searching base station cells.

### BACKGROUND OF THE INVENTION

Mobile terminals are widely used for wireless mobile communications of voice and/or data. As used herein, the term “mobile terminal” encompasses a wide variety of portable wireless devices that can access a cellular system. Mobile terminals include a cellular radiotelephone with a multi-line display, a Personal Communications System (PCS) terminal that may combine a cellular radiotelephone with data processing, facsimile and/or data communications capabilities, a Personal Digital Assistant (PDA) that can include a radiotelephone, pager, Internet/intranet access, Web browser, organizer, calendar and/or a Global Positioning System (GPS) receiver, and conventional laptop, palmtop and/or pervasive computing devices that include wireless receivers.

As is well known to those having skill in the art, in a terrestrial or satellite cellular system, one or more mobile terminals communicate with a plurality of cells that are served by base stations. A typical cellular system may include hundreds of cells, and may serve thousands of mobile terminals. The cells generally serve as nodes in the system from which links are established between mobile terminals and a Mobile Telephone Switching Office (MTSO) by way of the base stations serving the cells. Each cell may have allocated to it one or more dedicated control channels and one or more traffic channels. A control channel is a dedicated channel used for transmitting cell identification and paging information. The traffic channels carry the voice and/or data information. Through the cellular network, a duplexed radio communication link may be effected between two mobile terminals or between a mobile terminal and a land line terminal, through a Public Switched Telephone Network (PSTN).

Several types of access techniques are conventionally used to provide wireless services to users of cellular systems. Traditional analog cellular systems generally employ a system referred to as Frequency Division Multiple Access (FDMA), to create communications channels, wherein discrete frequency bands serve as channels over which mobile terminals communicate with base stations. Typically, these bands are reused in geographically separated cells in order to increase system capacity.

Modern digital cellular systems typically utilize different multiple access techniques, such as Time Division Multiple Access (TDMA) and/or Code Division Multiple Access (CDMA), to provide increased spectral efficiency. In TDMA systems, such as those conforming to the GSM or IS-136 Standards, carriers are divided into sequential time slots that are assigned to multiple channels, such that a plurality of channels may be multiplexed on a single carrier. CDMA systems, such as those conforming to the IS-95 Standard, use “spread spectrum” techniques, wherein a channel is defined by modulating a data-modulated carrier signal by a unique spreading code, i.e., a code that spreads an original data-modulated carrier over a wide portion of the frequency spectrum in which the communications system operates.

Conventional spread spectrum CDMA communications systems commonly use so-called “Direct Sequence” (DS) spread spectrum modulation. In DS modulation, a data-modulated carrier is directly modulated by a spreading code to differentiate different physical channels from the same base stations. The data-modulated carrier may be further modulated by a scrambling code to differentiate base stations from one another.

A CDMA mobile terminal may need to synchronize to the timing and the scrambling code used by a serving cell before any communications with the base station can take place. The process of searching for one or more cells is referred to as cell search. The mobile terminal may perform cell search after it has been switched on (initial search), while it is in an idle mode (not using a traffic channel), and/or while it is in a dedicated mode (actively using a traffic channel). During cell search, the mobile terminal may identify cells that may be used to initiate communications or handover.

In Wideband CDMA (WCDMA), a mobile terminal in idle mode generally performs three tasks:

1. Read the paging indication (PICH) signal and if it is set, the mobile terminal reads the paging channel (PCH).

2. Search for new neighbor cells with a three stage cell search on frequencies that are provided by a network.

3. Measure already identified neighbor cells on both the same frequency as the serving cell and on other carriers where cells are found.

For more information about basic techniques for making cell search in WCDMA, see, for example, Wang et al., Cell Search in WCDMA, IEEE Journal on Selected Areas in Communications, Vol. 18, No. 8, 2000, pp. 1470-1482, the disclosure of which is incorporated by reference herein in its entirety as if set forth fully herein.

In dedicated mode, the mobile terminal may support a so-called compressed mode in which it interleaves making measurements on the active communication frequency with making cell search measurements on other frequencies. The compressed mode in WCDMA is described further in 3rd Generation Partnership Project; Technical Specification Group Radio Access Network; Physical layer—Measurements (FDD) (Release 5), 3GPP TS 25.215, Version 5.1.0 (September 2002), the disclosure of which is incorporated by reference herein in its entirety as if set forth fully herein.

### SUMMARY OF THE INVENTION

In some embodiments of the present invention, a mobile terminal searches for a plurality of cells that can be received from a wireless communication system. The mobile terminal receives information from a plurality of cells and searches the information for a first synchronization code from at least one of the plurality of cells. The information is recorded, and the recorded information is searched for a second synchronization code from at least one of the plurality of cells using the information that was recorded and used to search for the first synchronization code. Accordingly, the mobile terminal may search the same information for both the first and second synchronization codes.

In further embodiments of the present invention, the mobile terminal includes a RF receiver that may be turned-off after the information is recorded. Accordingly, the mobile terminal may record the received information, and then conserve power by turning-off the RF receiver, while continuing to search for one or more synchronization codes. The information may be searched for the first synchronization code that may be common for the plurality of cells, and searched for the second synchronization code that may be a sequence of codes that is common for a subgroup of the plurality of cells. The information that was recorded, and used to search for the first synchronization code, may be further searched for a third code that is unique to one of the plurality of cells. The third code may be a scrambling code. The digital in-phase and quadrature signals that represent the received information may be recorded and searched.

In still other embodiments of the present invention, a wireless receiver that receives a RF signal may include a downconverter, an analog-to-digital converter, a buffer, and a controller. The downconverter converts a received RF signal to a baseband in-phase signal and a baseband quadrature signal. The analog-to-digital converter converts the baseband in-phase and quadrature signals to digital signals. The buffer records the digital in-phase and quadrature signals. The controller is configured to search for a second synchronization code using the digital in-phase and quadrature signals recorded in the buffer and that are used when searching for a first synchronization code. In other embodiments, the controller is further configured to turn-off the downconverter in response to completion of a recording of the digital in-phase and quadrature signals in the buffer.

In still other embodiments of the present invention, a mobile terminal is provided that includes a wireless receiver, a buffer, and a controller. The wireless receiver is configured to receive information from a plurality of cells. The buffer is configured to record the information. The controller is configured to search the information for a first synchronization code from at least one of the plurality of cells, and to search for a second synchronization code from at least one of the plurality of cells using the information that was recorded in the buffer and used to search for the first synchronization code.

### BRIEF DESCRIPTION OF THE DRAWINGS

FIG. 1 illustrates a timing of operations that can be performed by a mobile terminal in an idle mode, according to some embodiments of the present invention.

FIG. 2 illustrates a timing of operations that can be performed by a mobile terminal in a dedicated mode, according to some embodiments of the present invention.

FIG. 3 is a block diagram of a mobile terminal according to some embodiments of the present invention.

### DETAILED DESCRIPTION OF PREFERRED EMBODIMENTS

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

It also will be understood that, as used herein, the term “comprising” or “comprises” is open-ended, and includes one or more stated elements, steps and/or functions without precluding one or more unstated elements, steps and/or functions.

The present invention is described below with reference to block diagrams and/or operational illustrations of methods and mobile terminals according to embodiments of the invention. It is understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor of a general purpose computer, special purpose computer, and/or other programmable data processing apparatus in a mobile terminal, such that the instructions, which execute via the processor of the computer and/or other programmable data processing apparatus, create means for implementing the functions/acts specified in the block diagrams and/or operational block or blocks.

These computer program instructions may also be stored in a computer-readable memory that can direct a mobile terminal to function in a particular manner, such that the instructions stored in the computer-readable memory produce an article of manufacture including instructions which implement the functions/acts specified in the block diagrams and/or operational block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or operational block or blocks. It should also be noted that in some alternate implementations, the functions/acts noted in the blocks may occur out of the order noted in the operational timing illustrations. For example, two blocks shown in succession may in fact be executed substantially concurrently or the blocks may sometimes be executed in the reverse order, depending upon the functionality/acts involved.

According to some embodiments of the present invention, a mobile terminal can receive an information signal that includes information from a plurality of cells. The received information signal is recorded, and the recorded information is used to search for one or more of the cells.

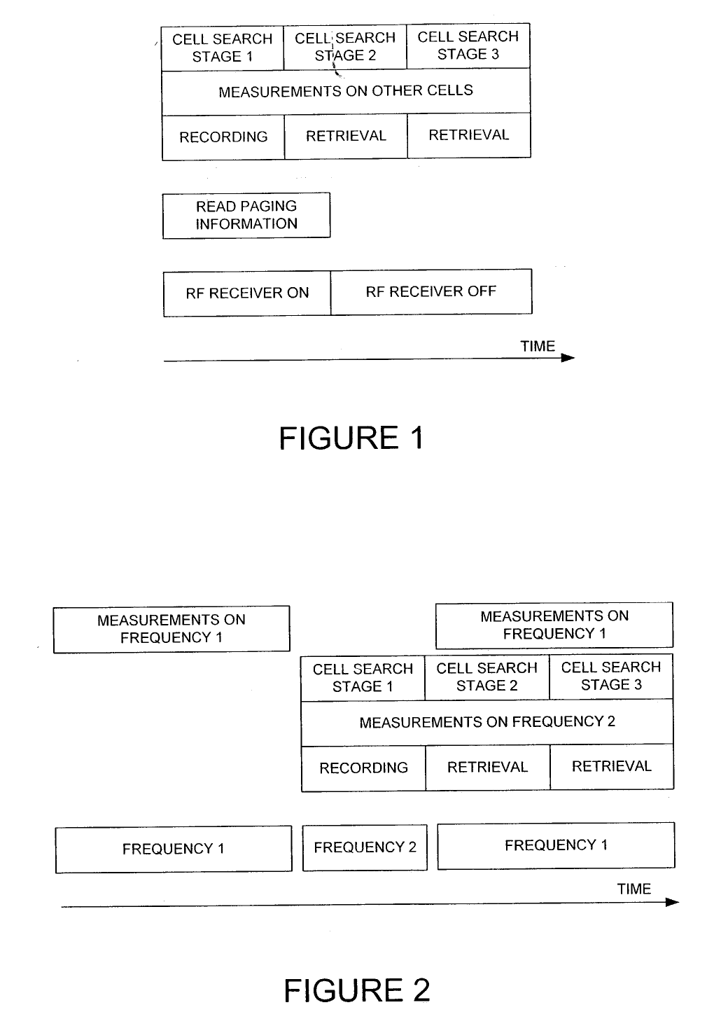

According to further embodiments of the present invention, a WCDMA mobile terminal that is in an idle mode (not actively using a traffic channel), may perform operations according to a timing diagram that is shown is FIG. 1. Information is received from a plurality of cells and is recorded. The mobile terminal may perform a three stage cell search, along with performing measurements on cells (including measuring the quality of communications links with cells), and read paging information using the information. The mobile terminal may perform the first stage of cell searching, making measurements, and reading of paging information in parallel on the received information and/or on the recorded information. Alternatively, or additionally, the first stage of cell searching may be performed while the received information is being recorded.

For the first stage of cell search, the mobile terminal may search the received information, or the recorded information, for a first synchronization code that is common to the plurality of cells. The mobile terminal may then use the information to determine slot timing information and to synchronize therewith.

In a second stage of cell search, the mobile terminal may search for a second synchronization code using the information that was recorded and used to search for the first synchronization code. The second synchronization code may include a sequence of codes that is common for a subgroup of the plurality of cells. The mobile terminal may then use the second synchronization code to obtain frame timing information and to synchronize therewith.

In a third stage of cell search, the mobile terminal may search for a third code that is unique to one of the plurality of cells using the information that was recorded and used to search for the first synchronization code. The third code may be a scrambling code that is unique to one of the plurality of cells. In some embodiments, the mobile terminal may search for a particular cell by comparing eight possible scrambling codes to the recorded information.

After the received information is recorded, or later after paging information is read from the received information, a RF receiver portion of the mobile terminal may be turned-off or the RF receiver portion may be tuned to receive information on other frequencies. Turning-off a portion of the receiver may conserve power and may extend the time during which a mobile terminal can operate from a battery.

According to still further embodiments of the present invention, a WCDMA mobile terminal that is in a dedicated mode (actively using a traffic channel), may interleave making measurements on a first frequency (active communication frequency) with making cell searches and measurements, on a second frequency. As shown in FIG. 2, after measurements are made on information that is received on a first frequency, the mobile terminal may record information from a second frequency. Cell searches and measurements may then be made on the information received from the second frequency and/or the recorded information. A first stage of cell search for a first synchronization code may be made using the information that is received on the second frequency or using information that is recorded therefrom. The second and third stages of cell search, for a second synchronization code and a third code, may be made using the information that was recorded from the second frequency and used to search for the first stage of cell search. After the information is recorded, the mobile terminal may switch back to the first frequency to continue making measurements and/or perform communication thereon.

Accordingly, the same recorded information may be used to search for cells and/or to measure characteristics of communication links with cells. By using the same recorded information for multiple stages of cell search, the information that is searched in each stage has the same timing and signal quality, which may simplify the search and provide improved comparisons between the results of each stage of cell search. Moreover, by performing cell searches on information that has been recorded from the second frequency, the mobile terminal may dwell for less time on the second frequency and more quickly switch back to the first frequency.

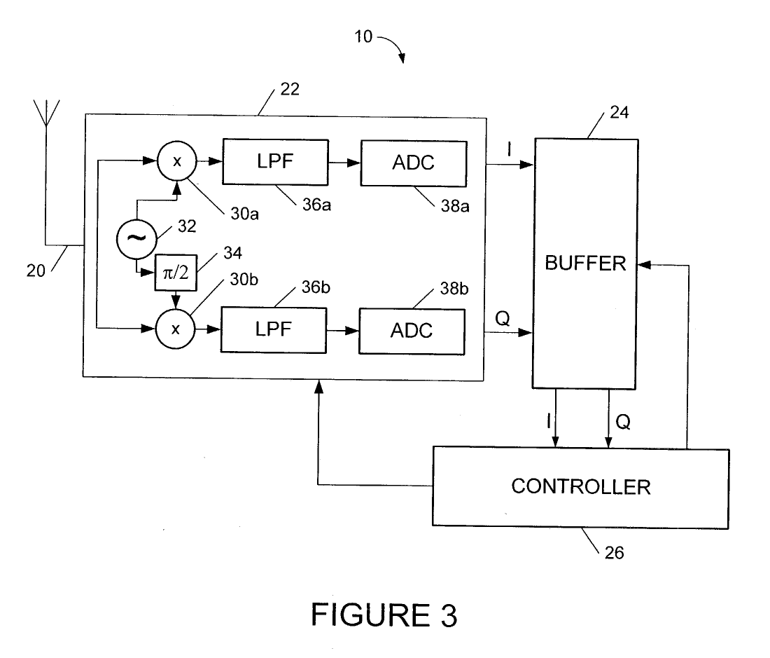

FIG. 3 is a block diagram of a mobile terminal 10, that may perform the operations described with regard to FIGS. 1 and 2, according to some embodiments of the present invention. The mobile terminal 10 can include an antenna 20, a wireless RF receiver 22, a buffer 24, and a controller 26. The RF receiver 22 receives from the antenna 20 an information signal from a plurality of cells. The receiver 22 may downconvert the frequency of the received information signal to a baseband frequency, and produce a digital in-phase (I) signal and digital quadrature (Q) signal that represent the received information signal. The digital in-phase and quadrature signals may be recorded in the buffer 24. The controller 26 may be configured to control recording and retrieval of the digital in-phase and quadrature signals in the buffer 24. The controller 26 may be further configured to turn-off all, or a portion of, the RF receiver 22 after the digital in-phase and quadrature signals are recorded in the buffer 24.

The controller 26 may be further configured to perform a three stage cell search using the digital in-phase and quadrature signals. According to some embodiments, the controller 26 searches the information for a first synchronization code, and searches for a second synchronization code using the digital in-phase and quadrature signals that are recorded in the buffer 24 and that were used when searching for the first synchronization code. In still further embodiments, the controller 26 searches the information for a third code, that is unique to one of the plurality of cells, using the digital in-phase and quadrature signals that are recorded in the buffer 24 and that were used when searching for the first synchronization code.

According to some embodiments of the present invention, the wireless RF receiver 22 includes a pair of multipliers 30a-30b that multiplies a received information signal by a carrier from an oscillator 32, such as a Voltage Controlled Oscillator (VCO). The multipliers 30a-30b and oscillator 32 form a downcoverter that downcoverts the received signal to a baseband signal. A quadrature shifter 34 shifts the phase of the signal provided to the multiplier 30b by 90° to provide a quadrature signal from the multiplier 30b while the multiplier 30a provides an in-phase signal. A pair of low pass filters (LPF) 36a-36b filter the in-phase and quadrature signals, respectively, to produce filtered signals. A pair of analog-to-digital converters (ADC) 38a-38b convert the filtered signals into digital in-phase and quadrature signals. The digital in-phase and quadrature signals are recorded by the buffer 24. After the signals are recorded in the buffer 24, the controller 26 may turn-off, or reduce power to, one or more portions of the RF receiver 22. According to some embodiments, the controller 26 may turn-off, or reduce power to, the oscillator 32, the quadrature shifter 34, the multipliers 30a-30b, the low pass filters 36a-36b, and/or the analog-to-digital converters 38a-38b. According to some other embodiments, the controller 26 may turn-off, or reduce power to, the downcoverter formed by the oscillator 32 and the multipliers 30a-30b.

According to other embodiments of the present invention, the in-phase and quadrature signals may be passed from the multipliers 30a-30b to the analog-to-digital converters 38a-38b without being filtered by low pass filters.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method for searching in a mobile terminal for a plurality of cells that can be received by the mobile terminal from a wireless communication system, the method comprising:
receiving information from a plurality of cells;
searching the information for a first synchronization code from at least one of the plurality of cells;
recording the information; and
searching for a second synchronization code from at least one of the plurality of cells using the information that was recorded and used to search for the first synchronization code.

2. A method according to claim 1 wherein:
the searching the information for a first synchronization code includes searching the information for the first synchronization code that is common for the plurality of cells; and
the searching for a second synchronization code includes searching the information for a sequence of codes that is common for a subgroup of the plurality of cells.

3. A method according to claim 2, further comprising searching for a third code that is unique to one of the plurality of cells using the information that was recorded and used to search for the first synchronization code.

4. A method according to claim 3, where in the searching for a third code comprises searching for a scrambling code that is unique to one of the plurality of cells.

5. A method according to claim 1 wherein the searching the information for the first synchronization code occurs while the information is being recorded.

6. A method according to claim 1 wherein the searching the information for the first synchronization code comprises searching the recorded information for the first synchronization code.

7. A method according to claim 1 wherein the recording the information comprises recording the digital in-phase and quadrature signals that represent the received information.

8. A method according to claim 1 wherein:
the searching the information for a first synchronization code includes obtaining slot timing information; and
the searching for a second synchronization code includes obtaining frame timing information.

9. A method according to claim 1 wherein the searching the information for a first synchronization code includes synchronizing to the first synchronization code.

10. A method according to claim 9 wherein the searching the information for a second synchronization code includes synchronizing to the second synchronization code using the information that was recorded and used to synchronize to the first synchronization code.

11. A method according to claim 1 further comprising measuring communication link quality values in the recorded information.

12. A method according to claim 1 wherein the mobile terminal comprises a RF receiver and the method further comprises turning-off the RF receiver after the information has been recorded.

13. A wireless receiver that can receive a RF signal comprising:
a downconverter that is configured to convert a received RF signal to a baseband in-phase signal and a quadrature signal;
an analog-to-digital converter that is configured to convert the baseband in-phase signal to a digital in-phase signal and is configured to convert the baseband quadrature signal to a digital quadrature signal;
a buffer that is configured to record the digital in-phase signal and the digital quadrature signal; and
a controller that is configured to search for a second synchronization code using the digital in-phase and quadrature signals recorded in the buffer and that are used when searching for a first synchronization code.

14. A wireless receiver according to claim 13 wherein the controller is further configured to turn-off the downconverter in response to completion of a recording of the digital in-phase and quadrature signals in the buffer.

15. A mobile terminal comprising:
a wireless receiver that is configured to receive information from a plurality of cells;
a buffer that is configured to record the information; and
a controller that is configured to search the information for a first synchronization code from at least one of the plurality of cells, and to search for a second synchronization code from at least one of the plurality of cells using the information that was recorded in the buffer and used to search for the first synchronization code.

16. A mobile terminal according to claim 15 wherein the controller is configured to turn-off the wireless receiver in response to the information being recorded in the buffer.

17. A mobile terminal according to claim 15 wherein the controller is configured to search the same information that is recorded in the buffer for the first synchronization code and the second synchronization code.

18. A mobile terminal according to claim 15 wherein the controller is further configured to search for a third code that is unique to one of the plurality of cells using the information that that was recorded in the buffer and used to search for the first synchronization code.

19. A mobile terminal according to claim 18 wherein the controller searches for the third code by searching for a scrambling code that is unique to one of the plurality of cells.

20. A mobile terminal according to claim 15 wherein the controller is configured to search for the first synchronization code that is common for the plurality of cells and to search for the second synchronization code that is a sequence of codes that is common for a subgroup of the plurality of cells.
